(19) United States
(12) Patent Application Publication
(10) Pub. No.: US 2006/0093738 A1
(43) Pub. Date: May 4, 2006

(54) Transparent ceramic structure and surface treatment method of the same

(76) Inventors: Yung-Jen Lin, Taipei City (TW); Jung-Chang Hu, Taipei City (TW); Chien-Ming Tseng, Waipu Township (TW); Hsuan-Peng Lin, Taoyuan (TW); Chih-Chao Hsu, Taipei City (TW)

Correspondence Address: J C PATENTS, INC., 4 VENTURE, SUITE 250, IRVINE, CA, 92618, US

(21) Appl. No.: 10/979,880

(22) Filed: Nov. 1, 2004

(51) Int. Cl. B05D 3/02; B05D 1/36; B05D 3/00

(52) U.S. Cl. 427/190; 427/193; 427/201; 427/204; 427/397.7; 427/398.1

(57) ABSTRACT

A transparent ceramic structure and a method of surface treatment thereof are disclosed. A glass powder is applied over an unpolished surface of an intrinsically transparent ceramic structure. The ceramic structure is then placed in high temperature which is higher than the melting temperature of the glass powder and lower than 1,700° C. for about 1 minute to about 5 minutes. The transparent ceramic structure is removed from the environment and cooled down so as to obtain the desired transparency and strength of the ceramic structure.

### BACKGROUND OF THE INVENTION

1. Field of the Invention

The present invention relates to a ceramic structure, and more particularly to a transparent ceramic structure and a method of surface treatment thereof.

2. Description of the Related Art

With the advance of technology, ceramic materials have high heat-resistance, high wear-resistance, high corrosion, erosion-resistance, lightness, excellent electrical-insulation and high heat-insulation, and become promising materials in the future. Ceramic material is usually non-transparent. Even intrinsically transparent ceramics could become opaque or translucent due to defects in the crystal structures. Due to micro pores, interfaces or surface roughness in ceramic materials, incident light will be absorbed or scattered by the ceramic material. Because of these defects, light cannot penetrate through the ceramic materials. Therefore, removing the structural defects can enhance the optical properties of the ceramic materials.

Infrared (IR) transparent ceramic is an important group of transparent crystalline ceramic material. It is a material developed for missiles. Usually, IR detectors are installed at the heads of missiles for tracing IR radiation from airplanes. As soon as detecting the IR radiation, missiles will follow airplanes and destroy the targets. Ceramic domes which have desired strength and IR transparency are used to cover IR detectors in order to protect the IR detectors. The material of the dome is a transparent ceramic material. In addition to the application in military, the transparent ceramic materials have been widely used in medical application and other high-technology equipment.

The transparent ceramic material, for example, sapphire, is usually cut from bulk into desired shapes. Then Chemical-Mechanical Polishing (CMP) was used to polish the sapphire to obtain the desired transparency. The CMP method, however, requires a long process time and high manufacturing costs. In addition to the issues regarding to the long process time and the high manufacturing costs, the degradation of the figh temperature mechanical strength of the ceramic material is another issue.

### SUMMARY OF THE INVENTION

Accordingly, the present invention is directed to a method of surface treatment for a transparent ceramic structure. The method of the present method can resolve the issue of high manufacturing costs and alleviate high-temperature mechanical properties degradation while maintaining the optical properties of the transparent ceramic structure are maintained.

The present invention is directed to a transparent ceramic structure with a smooth surface for transparency.

The present invention provides a method of surface treatment for a transparent ceramic structure. The method first applies a layer of glass powder over an unpolished surface of an instrinsically transparent ceramic structure. The ceramic structure is then placed in an environment with a temperature, wherein the temperature is higher than the melting temperature of the glass powder, but is lower than 1,700° C. The time which he ceramic structure is in high temperature is short, for example, 1˜5 minute. After that, the ceramic structure is cooled to obtain a smooth glass layer on the transparent ceramic structure so as to enhance the transparency of the transparent ceramic structure. Consequently, the ceramic structure does not need final mechanical polishing.

The present invention also provides a transparent ceramic structure fabricated by the method described above. This structure is characterized by a glass layer on the surface of the transparent ceramic.

The method regarding the surface treatment for a transparent ceramic structure is to apply a layer of glass powder over the unpolished surface of the intrinsically transparent ceramic structure, and fast heats and cools the whole structure so as to meet the glass and make the surface smooth and the whole structure transparent. By fast heating and cooling the glass on the unpolished surface of the transparent ceramic structure, the transparency of the ceramic structure is greatly improved, and the manufacturing costs and process time are reduced. Moreover, the method of surface treatment for the transparent ceramic structure enhances strength of the ceramic material.

The above and other features of the present invention will be better understood from the following detailed description of the preferred embodiments of the invention the accompanying drawings.

### BRIEF DESCRIPTION OF THE DRAWINGS

FIG. 1 is a flowchart showing a method of surface treatment for a transparent ceramic structure according to an embodiment of the present invention.

FIG. 2 is a figure showing the light transmission of an unpolished single-crystal sapphire, a polished single crystal sapphire and a single crystal sapphire whose unpolished surface was treated by the surface treatment according to the method of the present invention in the infrared (IR) range.

FIG. 3 is a figure showing the room-temperature strengths of an unpolished single-crystal sapphire, a polished single-crystal sapphire and a single-crystal sapphire whose unpolished surface was treated by fast heating and cooling surface treatment according to the method of the present invention.

FIG. 4 is a figure showing the high-temperature strength at 600° C. of an unpolished single-crystal sapphire, a polished single-crystal sapphire and a single-crystal sapphire whose unpolished surface was treated by fast heating and cooling surface treatment according to the method of the present invention.

### DESCRIPTION OF SOME EMBODIMENTS

Generally, the method for improving the transparence of the ceramic material is a by mechanical polishing. The mechanical polishing, however, is time-consuming and costly.

The present invention applies a layer of glass material over the unpolished surface of the intrinsically transparent ceramic structure and treats the surface of the ceramic structure so as to obtain the desired transparency of the ceramic structure. Following are the descriptions of a method of surface treatment for a transparent ceramic structure according to an embodiment of the present invention.

The method first applies a glass powder over the unpolished surface of the intrinsically transparent ceramic structure, wherein the ceramic structure can be single crystal sapphire, silicon carbide, Nd:YAG or Al₂O₃—spinel, and the glass powder can be a material such as germanate glass, arsenic sulfide (As₂S₃), germania silica glass, Ge—As—Se glass or calcium aluminate glass. The glass-covered ceramic structure is placed in an environment with high temperatures, wherein the temperature is higher than the melting temperature of the glass powder and is lower than 1,700° C. for about 1 minute to about 5 minutes. The ceramic structure is then cooled down, for example, in room temperature.

In this embodiment, the step of placing the transparent ceramic structure in the environment with high temperatures comprises placing the transparent ceramic structure in a furnace with the temperature.

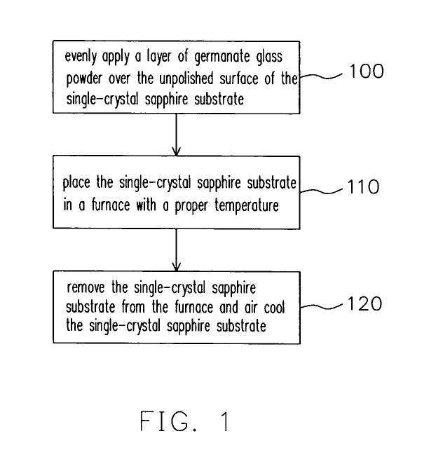

Following are the descriptions of an experimental embodiment. FIG. 1 is a flowchart showing a method of surface treatment for a transparent ceramic structure according to an embodiment of the present invention. Referring to FIG. 1, the germanate glass powder is evenly applied over the unpolished surface of the single-crystal sapphire substrate in the step 100. The single-crystal sapphire substrate is then placed in a furnace with a proper temperature in the step 110. The temperature is between about 1450° C. to about 1650° C. for about 1 minute to about 5 minutes. The single-crystal sapphire substrate is removed from the furnace and air cooled in the step 120. The surface treatment for the transparent ceramic structure is completed.

Before the surface treatment for the transparent ceramic structure, the unpolished ceramic structure is non-transparent. After the fast heating and cooling treatments, the ceramic structure becomes transparent. The method applies the glass material over the unpolished surface of transparent ceramic structure, and fast heats and cools the surface of the ceramic structure so as to obtain desired transparency of the ceramic structure. Accordingly, the present invention solves the problems regarding the long process time and high manufacturing costs of mechanical polishing.

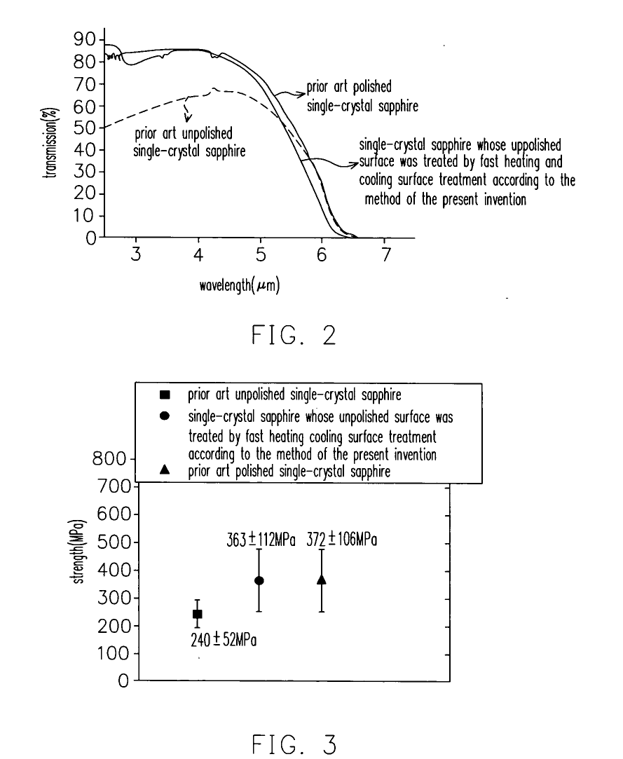

FIG. 2 is a figure showing the light transmission for the surface-modified unpolished ceramic structure, the prior art unpolished ceramic structure and the prior art polished ceramic structure in the infrared (IR) range. The samples tested in the experiments include an unpolished single-crystal sapphire, a polished single-crystal sapphire and a single-crystal sapphire with an unpolished surface after fast heating and cooling surface treatment according to the method of the present invention. Referring to FIG. 2, the prior art unpolished single-crystal sapphire has the lowest IR transmission. The single-crystal sapphire with an unpolished surface after fast heating and cooling surface treatment according to the method of the present invention has the transmission about 85% in the wavelength range from about 3 μm to about 5 μm, which is similar to that of the mechanically polished single-crystal sapphire.

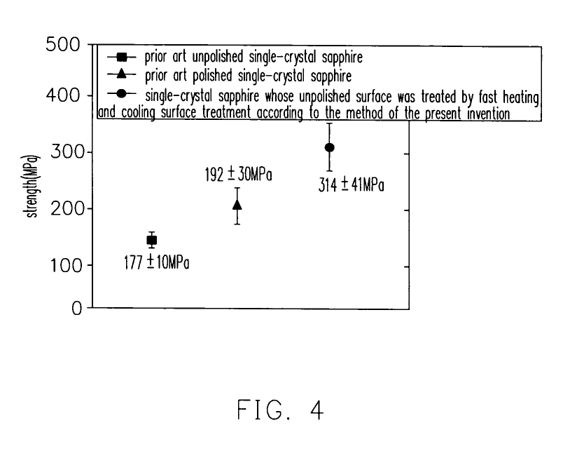

FIG. 3 is a figure showing the room-temperature strengths of an unpolished single-crystal sapphire, a polished single-crystal sapphire and a single-crystal sapphire whose unpolished surface was treated by fast heating and cooling surface treatment according to the method of the present invention. Referring to FIG. 3, the strengths of the unpolished single-crystal sapphire, a polished single-crystal sapphire and a single-crystal sapphire with an unpolished surface after fast heating and cooling surface treatment are 240±52 MPa, 372±106 MPa and 363±112 MPa, respectively. According to the test, the prior art unpolished single-crystal sapphire has the lowest strength. The single-crystal sapphire with an unpolished surface after fast heating and cooling surface treatment according to the method of the present invention has the strength similar to that of the mechanically polished single-crystal sapphire, which is better than the strength of the prior art unpolished single-crystal sapphire.

From the IR transmission test and the room-temperature strength test, the IR transmission and the strength of the surface-modified unpolished transparent ceramic structure are better than those of the prior art unpolished ceramic structure, and similar to those of the prior art polished ceramic structure. Accordingly, the transparent ceramic structure formed by the method of the present invention maintains the optical properties similar to that of the prior art mechanically polished ceramic structure with the advantages of short process time and low manufacturing costs.

FIG. 4 is a figure showing the high temperature strengths at 600° C. of an unpolished single-crystal sapphire, a polished single-crystal sapphire and a single-crystal sapphire whose unpolished surface was treated by fast heating and cooling surface treatment according to the method of the present invention. The samples tested by the experiments include unpolished disks of single-crystal sapphire, mechanically polished disks of single-crystal sapphire and disks of single-crystal sapphire with unpolished surface treated by fast heating and cooling surface treatment according to the method of the present invention. Referring to FIG. 4, the strengths of the unpolished single-crystal sapphire, mechanically polished single-crystal sapphire and a single-crystal sapphire with unpolished surface treated by fast heating and cooling surface treatment are 177±10 MPa, 192±30 MPa and 314±41 MPa, respectively. According to the test, the single-crystal sapphire with unpolished surface treated by fast heating and cooling surface treatment according to the method of the present invention has higher strength at 600° C. than those of the polished single-crystal sapphire and the prior art unpolished single-crystal sapphire.

Referring to FIGS. 3 and 4, the prior art polished transparent ceramic structure has strength of 372±1106 MPa at the room temperature, and strength of 192±130 MPa at 600° C. Therefore, the strength of the prior art mechanically polished transparent ceramic structure will substantially decline at high temperature. Referring to FIGS. 3 and 4, the unpolished single-crystal sapphire after surface treatment according to the present invention has strength 363±112 MPa at the room temperature and strength of 314±41 MPa at 600° C. Accordingly, the transparent ceramic structure with fast heating and cooling surface treatment according to the present invention maintains strength even under high temperature. Its mechanical strength will not significantly decrease as the temperature increase to 600° C.

The method of surface treatment for a transparent ceramic structure in the present invention is to apply glass powder over the unpolished surface of the intrinsically transparent ceramic structure, and fast heats and cools the surface of the ceramic structure so as to form the transparent ceramic structure with short process time and low manufacturing costs. The IR transmission test and strength test at room temperature show that the method of the present invention makes unpolished ceramic structure achieve the IR transmission and strength comparable to those of prior art mechanically polished counterparts. By comparing the strength at high temperature, the transparent ceramic structure formed by the present invention maintains its mechanical strength. This could resolve the declining of the mechanical properties at the high temperature. For quality inspection of the transparent ceramic structure, the mechanical polishing process is not required. Accordingly, the fine polishing process for the ceramic structure can be eliminated and the manufacturing costs are reduced.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. A method of surface treatment for a radioactive transparent ceramic structure, comprising:
applying a glass powder over a surface of a non-transparent ceramic structure, wherein the non-transparent ceramic structure is no mechanically polished;
placing the glass powder coated non-transparent ceramic structure in an environment with a temperature for about 1 minute to about 5 minutes, wherein the temperature is higher than the melting temperature of the glass powder, but is lower than 1700° C.; and
cooling the glass powder coated non-transparent ceramic structure with being covered by the glass powder so as to convert the glass powder coated non-transparent ceramic structure into a radioactive transparent structure with an enhanced strength.

2. The method of surface treatment for a radioactive transparent ceramic structure of claim 1, wherein the non-transparent ceramic structure is made of single crystal sapphire, silicon carbide, Nd:YAG or Al₂O₃—spinel.

3. The method of surface treatment for a radioactive transparent ceramic structure of claim 1, wherein the glass powder comprises germanate glass, arsenic sulfide (As₂S₃), germania silica glass, Ge—As—Se glass or calcium aluminate glass.

4. The method of surface treatment for a radioactive transparent ceramic structure of claim 1, wherein the glass powder comprises germanate glass and the temperature is between about 1450° C. to about 1650° C.

5. The method of surface treatment for a radioactive transparent ceramic structure of claim 1, wherein the step of placing the glass powder coated non-transparent ceramic structure in the environment comprises placing the glass powder coated non-transparent ceramic structure in a furnace with the temperature.

6. The method of surface treatment for a radioactive transparent ceramic structure of claim 4, wherein the step of cooling the glass powder coated non-transparent ceramic structure comprises air cooling the glass powder coated non-transparent ceramic structure.

7. The method of surface treatment for a radioactive transparent ceramic structure of claim 1, wherein the step of cooling the glass powder coated non-transparent ceramic structure comprises cooling the glass powder coated non-transparent ceramic structure at about room temperature.

8-10. (canceled)
